(19) United States
(12) Patent Application Publication
(10) Pub. No.: US 2015/0109569 A1
(43) Pub. Date: Apr. 23, 2015

(54) LIQUID CRYSTAL DISPLAY DEVICE

(71) Applicant: Japan Display Inc., Tokyo (JP)

(72) Inventors: Noboru KUNIMATSU, Tokyo (JP); Yasushi TOMIOKA, Tokyo (JP); Toshiyuki HIGANO, Tokyo (JP); Emi HIGANO, Tokyo (JP); Midori TSUKANE, Tokyo (JP); Hirofumi WAKEMOTO, Tokyo (JP); Kazuhiro NISHIYAMA, Tokyo (JP)

(73) Assignee: Japan Display Inc.

(21) Appl. No.: 14/519,515

(22) Filed: Oct. 21, 2014

(30) Foreign Application Priority Data
Oct. 22, 2013 (JP) 2013-219599

(51) Int. Cl. G02F 1/1339; G02F 1/1337

(52) U.S. Cl. CPC G02F 1/1339; G02F 1/1337; G02F 1/133734
USPC 349/123

(57) ABSTRACT

An object of the present invention is to realize a liquid crystal display device having a photo-aligned alignment film in which the alignment film is overlapped with a seal material to downsize a frame area, and the reliability of a seal portion can be secured. A first alignment film and a second alignment film are overlapped with a seal material, the first alignment film and the second alignment film are made of material containing 0.5 wt % or larger and 2 wt % or smaller of an amine-system silane coupling agent, and the shrinkage ratio and the storage elastic modulus of the seal material evaluated using the modulus of volume change by a specific gravity cup method are 5.1% or smaller and 9.2 Pa or smaller, respectively. Accordingly, a frame area can be downsized, and the reliability of a seal portion can be maintained.

### CLAIM OF PRIORITY

The present application claims priority from Japanese Patent Application JP 2013-219599 filed on Oct. 22, 2013, the content of which is hereby incorporated by reference into this application.

### BACKGROUND

The present invention relates to a display device, and particularly to a liquid crystal display device that can realize a so-called narrow frame in which a display area is enlarged relative to a predetermined outline using a photo-alignment process.

In a liquid crystal display device, disposed are a TFT substrate on which pixels having pixel electrodes and thin-film transistors (TFTs) are formed in a matrix shape and an opposed substrate which is opposed to the TFT substrate and on which color filters and the like are formed at positions corresponding to the pixel electrodes of the TFT substrate. In addition, liquid crystal is sandwiched between the TFT substrate and the opposed substrate. Further, the transmittance of light by liquid crystal molecules is controlled for each pixel to form an image.

The liquid crystal display device has been widely spread in various fields due to the flat shape and light weight. A small-sized liquid crystal display device has been widely used in a mobile phone, a DSC (Digital Still Camera), and the like. There has been a strong demand of enlarging the display area while keeping the outline small in the small-sized liquid crystal display device. In order to satisfy the demand, a width between an end portion of the display area and an end portion of the liquid crystal display device becomes narrow, and thus it is necessary to form the liquid crystal display device in a so-called narrow frame shape.

A seal material that allows the TFT substrate and the opposed substrate to adhere to each other is formed at a frame area. Further, an alignment film used for initially aligning liquid crystal is formed at the display area of the liquid crystal display device. The alignment film needs to reliably cover the display area. Thus, the area of the alignment film to be applied needs to be increased by a predetermined width relative to the display area. The alignment processes of the alignment film include a rubbing method and a photo-alignment process (hereinafter, referred to as photo-alignment). Japanese Unexamined Patent Application Publication No. 2004-206091 describes that using the photo-alignment, the disorder of alignment caused by complicated step structures in pixels is reduced, and affects of static electricity generated at the time of rubbing, the disorder of tips of a rubbing cloth, and foreign substances generated by rubbing can be prevented.

For the liquid crystal display device, a so-called viewing angle is important. In an IPS (In-Plane Switching) method, liquid crystal molecules are allowed to be rotated in the direction parallel to the substrate, so that the amount of light passing through the liquid crystal layer is controlled. Thus, the IPS method is excellent in characteristics of the viewing angle. On the other hand, a so-called pretilt angle is not necessary for the IPS liquid crystal display device. Thus, the IPS liquid crystal display device is suitable for photo-alignment.

In particular, if a photo-aligned alignment film is provided between the seal material and the TFT substrate, or between the seal material and the opposed substrate, the reliability of adhesion of the seal material is deteriorated in a conventional configuration. Thus, end portions of the alignment film to be applied need to be strictly controlled so as not to be overlapped with the seal material.

The alignment film is applied by printing or inkjet. The material of the alignment film is liquid, and spread in wet conditions. Thus, it is difficult to control the end portions of the alignment film to be applied. In particular, in the case where the alignment film is applied by inkjet, it is difficult to control due to a low degree of viscosity of the material of the alignment film. Japanese Unexamined Patent Application Publication No. 2011-145535 describes a configuration in which a frame-like second alignment film is formed outside an alignment film formed in a display area, and the second alignment film is used as a stopper for the alignment film formed in the display area, so that the range of the alignment film to be applied in the display area is controlled.

### SUMMARY

The IPS liquid crystal display device is excellent in characteristics of the viewing angle, and has been widely spread. Further, the pretilt angle is not necessary for the IPS method. Thus, the IPS method is suitable for the photo-alignment process. The photo-alignment process of the alignment film is a method in which polarized UV light is irradiated on the alignment film to generate uniaxial anisotropy in the alignment film. The uniaxial anisotropy is not generated on the uppermost surface as in a conventional rubbing process, but is generated across the entire layer of the alignment film. This is because only the surface is rubbed in the rubbing process, whereas the alignment process is performed at any depth position in the thickness direction in a range where the polarized UV light passes through in the photo-alignment process. If anisotropy is generated on the entire layer of the alignment film, polymers forming the alignment film are aligned in one direction. Such polymers are weak in the film strength in the direction orthogonal to the molecule alignment direction. Thus, it is conceivable that the film strength is reduced as compared to random polymers having no anisotropy. When the film strength of the alignment film is reduced and when a seal material is applied on the alignment film to form cells, the cells are likely to be peeled off due to the alignment film in a cell peeling test, and the reliability of the cells is deteriorated. There are photodimerization-type, photoisomerization-type, and photodegradation-type photo-alignment films, and the above-described alignment film fits into any type of photo-alignment film.

Therefore, a conventional photo-alignment film has been formed so as not to be overlapped with a seal material as shown in FIG. 11 and FIG. 12. FIG. 11 is a plan view of a conventional liquid crystal display device. In FIG. 11, an opposed substrate on which a color filter and the like are formed adheres to a TFT substrate on which TFTs and pixel electrodes are formed through a seal material, and liquid crystal (not shown) is sandwiched between the TFT substrate and the opposed substrate.

An alignment film is formed on the TFT substrate or the opposed substrate. As described above, the film strength of the photo-aligned alignment film is reduced, and the reliability is deteriorated. Thus, end portions of the alignment film have been formed on the inner side relative to the seal material in the conventional technique as shown in FIG. 11. On the other hand, the display area needs to be reliably covered with the alignment film, and thus end portions of the display area need to be formed on the farther inner side relative to the alignment film. In order to realize this, it is difficult to downsize a so-called frame area x from an end portion of the display area to an end portion of the opposed substrate. In addition, it is difficult to enlarge the area of the display area relative to the outline of the liquid crystal display device.

FIG. 12 is a cross-sectional view taken along the line B-B of FIG. 11. In FIG. 12, for example, a gate insulating film 101 is formed on a TFT substrate 100 made of glass, and a passivation film 102 is formed on the gate insulating film 101. An interlayer insulating film 103 is formed on the passivation film 102. The gate insulating film 101, the passivation film 102, the interlayer insulating film 103, and the like can be formed using SiN and the like by sputtering or CVD. The layer structure is an example, and other layer structures may be employed in some cases.

A photo-aligned alignment film 110 is formed on the interlayer insulating film 103. The conventional photo-aligned alignment film 110 has a problem of film strength. Thus, the alignment film 110 is formed so as not to be overlapped with a seal material 150. The alignment film 110 is formed by offset printing, an ink-jet method, or the like. A display area 10 is formed on the inner side relative to end portions of the alignment film 110.

On the other hand, a color filter 201 and a black matrix 202 are formed on an opposed substrate 200 made of glass. In addition, an overcoat film 203 is formed so as to cover the black matrix 202 and the color filter 201. On the overcoat film 203, formed is the photo-aligned alignment film 110. However, the alignment film 110 has a problem of film strength as similar to the TFT substrate 100. Thus, the alignment film 110 is formed so as not to be overlapped with the seal material 150. In addition, the display area 10 is formed on the inner side relative to end portions of the alignment film 110.

As described above, the alignment film 110 has a problem of film strength in the conventional example. Thus, the alignment film 110 is formed so as not to be overlapped with the seal material 150, and the display area 10 needs to be completely covered with the alignment film. Accordingly, the frame area x in FIG. 11 or FIG. 12 cannot be sufficiently downsized. Therefore, it has been impossible to adequately respond to a request of enlarging the display area 10.

An object of the present invention is to realize a liquid crystal display device in which even a photo-aligned alignment film 110 can be formed up to end portions of a TFT substrate 100 or an opposed substrate 200 and can be overlapped with a seal material 150.

The present invention has been achieved to overcome the above-described problems, and concrete means is as follows.

(1) Provided is a liquid crystal display device in which a first substrate having a first alignment film and a second substrate having a second alignment film adhere to each other through a seal material, and liquid crystal is sandwiched between the first substrate and the second substrate, wherein the first alignment film and the second alignment film are overlapped with the seal material, the first alignment film and the second alignment film are made of material containing 0.5 wt % or larger and 2 wt % or smaller of a silane coupling agent, and the shrinkage ratio and the storage elastic modulus of the seal material evaluated using the modulus of volume change by a specific gravity cup method are 5.1% or smaller and 9.2 Pa or smaller, respectively.

(2) Provided is a liquid crystal display device in which a first substrate having a first alignment film and a second substrate having a second alignment film adhere to each other through a seal material, and liquid crystal is sandwiched between the first substrate and the second substrate, wherein the first alignment film and the second alignment film are overlapped with the seal material, the first alignment film and the second alignment film are made of material containing 0.3 wt % or larger and smaller than 0.5 wt % of a silane coupling agent, and the shrinkage ratio and the storage elastic modulus of the seal material evaluated using the modulus of volume change by a specific gravity cup method are 3.1% or smaller and 9.0 Pa or smaller, respectively.

(3) Provided is the liquid crystal display device in which an amine-system silane coupling agent is used as the silane coupling agent.

According to the present invention, the seal material can be overlapped with the alignment film in the liquid crystal display device having the photo-aligned alignment film. Thus, a so-called frame area can be downsized, and the area of the display area can be enlarged in the liquid crystal display device having a predetermined outline. The present invention is advantageous especially in an IPS liquid crystal display device having a photo-aligned alignment film.

### BRIEF DESCRIPTION OF THE DRAWINGS

FIG. 1 is a plan view of a liquid crystal display device according to the present invention;

FIG. 2 is a cross-sectional view taken along the line A-A of FIG. 1;

FIG. 3 are diagrams each showing a shape of a sample for which the adhesive strength of a seal portion is tested;

FIG. 4 is a schematic view for showing a method of evaluating the adhesive strength of the seal portion;

FIG. 5 shows an example of an epoxy-system silane coupling agent;

FIG. 6 shows an example of an amine-system silane coupling agent;

FIG. 7 shows an example of characteristics of a seal material;

FIG. 8 shows a comparison example of the adhesive strength of the seal portion in the case where the amine-system and epoxy-system silane coupling agents are used for an alignment film using a seal material ZZ;

FIG. 9 shows a comparison example of the adhesive strength of the seal portion in the case where the amine-system and epoxy-system silane coupling agents are used for the alignment film using a seal material AA;

FIG. 10 shows an example of combinations of the amine-system silane coupling agent and the seal material that realize an adhesive strength of 30N in the seal portion;

FIG. 11 is a plan view of a liquid crystal display device in a conventional example; and

FIG. 12 is a cross-sectional view taken along the line B-B of FIG. 11.

### DETAILED DESCRIPTION

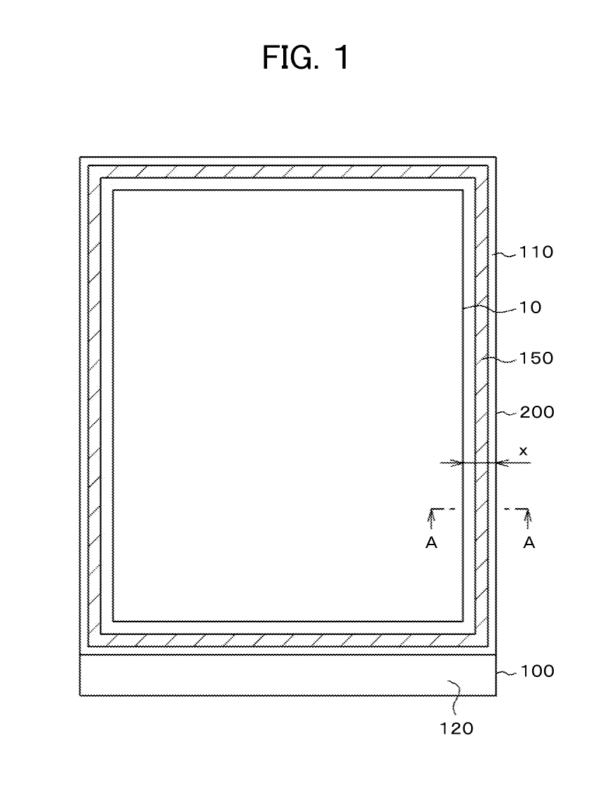

FIG. 1 is a plan view of a liquid crystal display device according to the present invention. In FIG. 1, an opposed substrate 200 on which a color filter 201 and the like are formed adheres to a TFT substrate 100 on which TFTs and pixel electrodes are formed through a seal material 150, and liquid crystal (not shown) is sandwiched between the TFT substrate 100 and the opposed substrate 200. A photo-aligned alignment film 110 is formed on the TFT substrate 100 or the opposed substrate 200.

FIG. 1 is characterized in that the alignment film 110 is formed up to end portions of the TFT substrate 100 or the opposed substrate 200. Specifically, the alignment film 110 and the seal material 150 are overlapped with each other. In the present invention, as will be described later, the seal material 150 and the alignment film 110 are specially configured to prevent the adhesive force of the seal portion from being reduced, and thus the configuration as shown in FIG. 1 can be realized.

As shown in FIG. 1, the alignment film 110 and the seal material 150 can be overlapped with each other, and thus a display area 10 can be formed closer to the seal material 150. Therefore, a frame area represented by x in FIG. 1 can be downsized, and the area of the display area 10 can be enlarged relative to the liquid crystal display device having a predetermined outline.

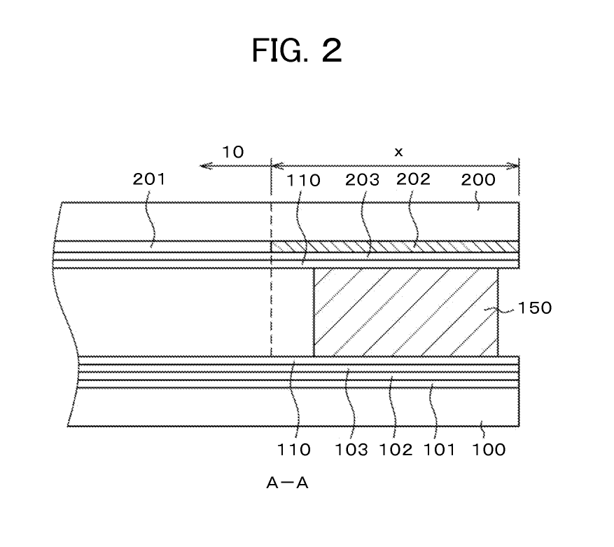

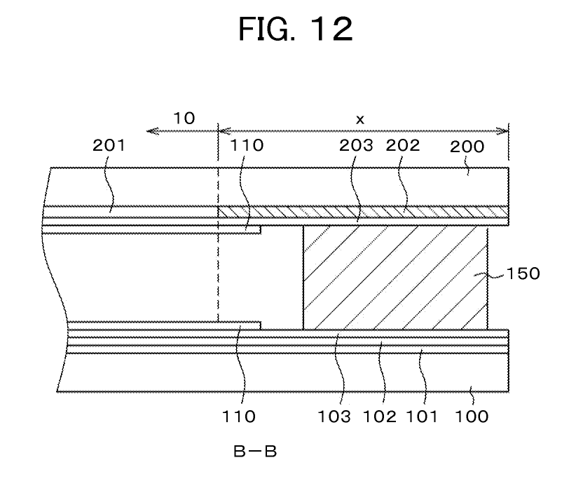

FIG. 2 is a cross-sectional view taken along the line A-A of FIG. 1. In FIG. 2, for example, a gate insulating film 101 is formed on the TFT substrate 100 made of glass, and a passivation film 102 is formed on the gate insulating film 101. An interlayer insulating film 103 is formed on the passivation film 102. On the interlayer insulating film 103, formed is the photo-aligned alignment film 110. FIG. 2 is largely different from FIG. 12 showing a conventional example in that the alignment film 110 is formed up to end portions of the TFT substrate 100. The present invention realizes the structure by specially configuring the alignment film 110 and the seal material 150.

As described above, the alignment film 110 is formed up to end portions of the TFT substrate 100. Thereby, it is not necessary to strictly control the outline of the alignment film 110, and the alignment film 110 can be easily formed. It should be noted that it is not necessary to form the alignment film 110 up to end portions of the TFT substrate 100. The alignment film 110 may be partially formed on the seal material 150 as long as the alignment film 110 sufficiently covers the display area 10. In this case, too, the alignment film 110 and the seal material 150 may be overlapped with each other. Thus, it is not necessary to accurately control the outline of the alignment film 110 as the conventional example. The alignment film 110 may be formed by offset printing, an ink-jet method, or the other methods.

On the other hand, the color filter 201 and a black matrix 202 are formed on the opposed substrate 200 made of glass. In addition, an overcoat film 203 is formed so as to cover the black matrix 202 and the color filter 201. On the overcoat film 203, formed is the photo-aligned alignment film 110. FIG. 2 is largely different from FIG. 12 showing a conventional example in that the alignment film 110 is formed up to end portions of the opposed substrate 200. The present invention realizes the structure by specially configuring the alignment film 110 and the seal material 150.

As described above, the alignment film 110 is formed up to end portions of the opposed substrate 200. Thereby, it is not necessary to particularly control the outline of the alignment film 110, and the alignment film 110 can be easily formed. It should be noted that it is not necessary to form the alignment film 110 up to end portions of the opposed substrate 200. The alignment film 110 may be partially formed on the seal material 150 as long as the alignment film 110 sufficiently covers the display area 10. In this case, too, the alignment film 110 and the seal material 150 may be overlapped with each other. Thus, it is not necessary to accurately control the outline of the alignment film 110 as the conventional example.

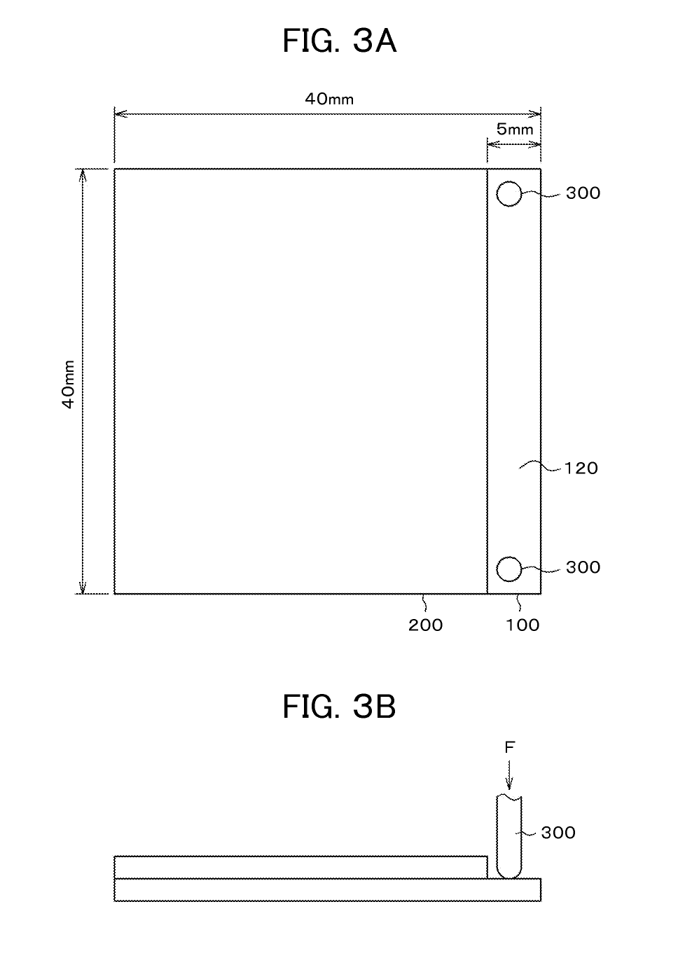

An object of the present invention is to realize a configuration in which the necessary and sufficient adhesive strength of the seal portion can be kept even in the liquid crystal display device having the photo-aligned alignment film 110. In order to achieve the object, it is necessary to evaluate the adhesive strength of the seal portion. FIG. 3 show an example of a sample of a liquid crystal display panel to evaluate the adhesive strength of the seal portion. FIG. 3A is a plan view of the sample, and FIG. 3B is a side view of the sample.

In FIG. 3A, the opposed substrate 200 adheres to the TFT substrate 100 through the seal material (not shown). As shown in FIG. 3B, pressurizing pins 300 are allowed to be pressed against a terminal portion 120, so that peeling stress is applied to the TFT substrate 100 and the opposed substrate 200 to evaluate whether or not a force F when the TFT substrate 100 and the opposed substrate 200 are peeled off from each other is a predetermined value or larger. The predetermined value is 30N. If the force F is 30N or larger, the adhesive strength of the seal portion can be evaluated as a sufficient level. In FIG. 3A, the pressurizing pins 300 are shown at two points of the terminal portion 120. The force F is not simultaneously applied to the pressurizing pins 300 at the two points, but is applied to each of the pressurizing pins. Accordingly, two pieces of data can be obtained from one sample.

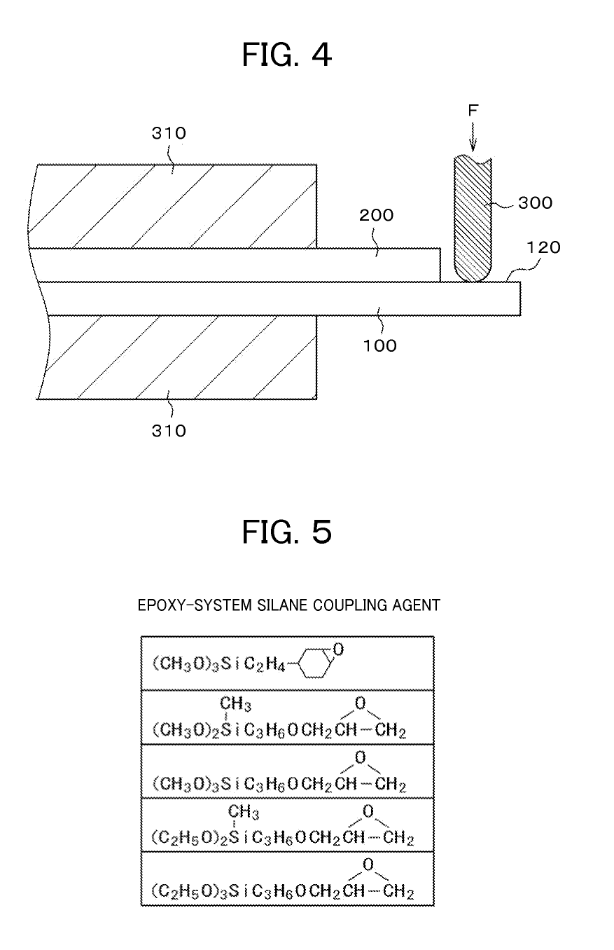

FIG. 4 is a diagram in which the adhesive strength of the seal portion is measured in the liquid crystal display panel of the sample. The liquid crystal display panel in which the TFT substrate 100 and the opposed substrate 200 adhere to each other through the seal material (not shown) is held by a presser jig 310. The force F is applied from the upper side to the terminal portion 120 of the liquid crystal display panel by the pressurizing pin 300 to measure the force by which the TFT substrate 100 is peeled off from the opposed substrate 200.

In this case, if the adhesive strength of the seal material 150 is sufficiently strong, the terminal portion 120 of the TFT substrate 100 is destroyed. If the peeling strength at the seal portion between the TFT substrate 100 and the opposed substrate 200 is 30N or larger, the adhesive strength of the seal portion may be regarded as a highly reliable strength. Thereafter, the sufficient reliability of the seal portion is evaluated on the basis of whether or not the adhesive strength of the seal portion is 30N or larger. Characteristics of the present invention will be described using the following example.

### First Example

The present invention is characterized in that a special material is used for the alignment film to be photo-aligned, and the shrinkage ratio and the storage elastic modulus of the seal material are set at predetermined values or smaller to improve the adhesive strength between the alignment film and the seal material at the seal portion. In addition, a sufficient degree of reliability is obtained by allowing the photo-aligned alignment film to adhere to the seal material at the seal portion.

The photo-aligned alignment film is made of polyimide material, and used is a solution obtained by dissolving the precursor in a solvent of a mixture of NMP (N-Methyl-2-pyrrolidone), GBL (γ-Butyrolactone), BC (Ethylene Glycol Monobutyl Ether), and the like. Further, a silane coupling agent is added to the solution. It should be noted that the solvent may include all of NMP, GBL, and BC, or may include two kinds or one kind thereof.

For example, when forming a photodegradation-type photo-alignment film, a solution containing polyamide acid may be used, or a solution containing polyamide acid ester and polyamide acid may be used. If the solution containing polyamide acid ester and polyamide acid is applied onto a substrate, the layers are separated from each other. Thus, the lower layer becomes a solution of polyamide acid, and the upper layer becomes a solution of polyamide acid ester. If the alignment film is dried and baked, a lower alignment film containing polyamide acid as a precursor is formed in the lower layer and an upper alignment film containing polyamide acid ester as a precursor is formed in the upper layer. Of these films, the alignment film containing polyamide acid ester as a precursor that is formed in the upper layer is to be photo-aligned. In the example, a photodegradation-type photo-alignment film is exemplified. The structural formula of the precursor of polyimide material in this case is shown as (Chemical formula 1). It is obvious that a photodimerization-type or photoisomerization-type photo-alignment film may be used.

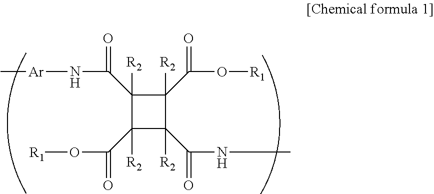

In Chemical formula (1), each R1 represents a 1 to 8C alkyl group or a hydrogen atom, each R2 represents a hydrogen atom, a fluorine atom, a chlorine atom, a bromine atom, a phenyl group, a 1 to 6C alkyl group, a 1 to 6C alkoxy group, a vinyl group (—(CH2) m-CH═CH2, m=0, 1, 2) or an acetyl group (—(CH2) m-C≡CH, m=0, 1, 2), and Ar represents an aromatic compound.

As a silane coupling agent, an epoxy-system silane coupling agent was used in the conventional technique. 5 kinds of epoxy-system silane coupling agents are exemplified in FIG. 5. In this case, after the photo-alignment process, it has been difficult to sufficiently secure the strength of the alignment film and the adhesive force between the alignment film 110 and the TFT substrate 100 or the opposed substrate 200.

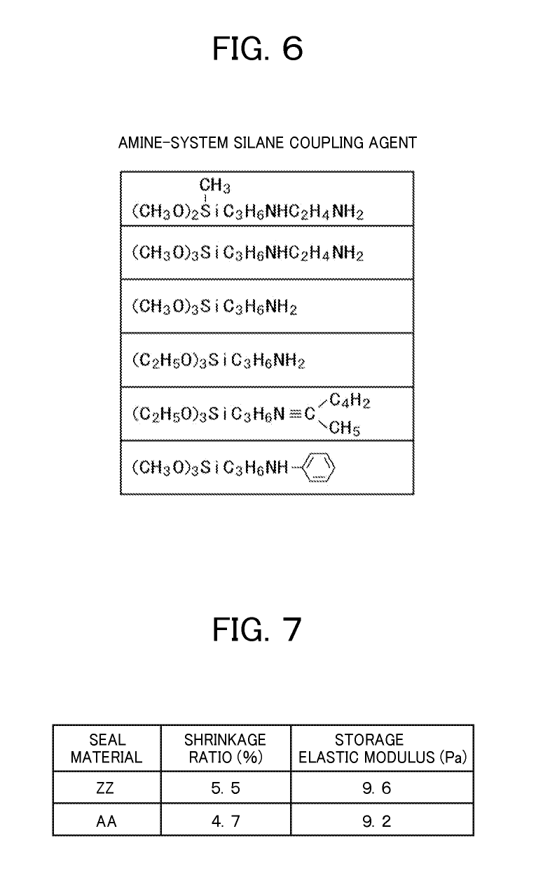

The inventors have found that the strength of the alignment film and the adhesive force with the substrate can be kept at a high level even after the photo-alignment process by using an amine-system silane coupling agent instead of the epoxy-system silane coupling agent. 6 kinds of amine-system silane coupling agents are exemplified in FIG. 6. However, if an excessive amount of amine-system silane coupling agent is used, a so-called AC afterimage is deteriorated. The AC afterimage is an afterimage caused by deterioration of the alignment characteristics of the alignment film in a long-term operation. The AC afterimage is deteriorated because an interaction (alignment restricting force) between the alignment film and the liquid crystal molecules is inhibited due to the existence of the silane coupling agent on the surface of the alignment film.

On the other hand, if an insufficient amount of amine-system silane coupling agent is used, the role as the coupling agent cannot be sufficiently exerted. On the assumption that the amount of amine-system silane coupling agent in the material of the alignment film is in a range between 0.3 wt % and 2.0 wt %, the cohesion strength of the seal portion can be sufficiently kept and the afterimage characteristics can be suppressed within a practical range when a specific seal material is used.

Used was a solution obtained by dissolving the precursor of a photodegradation-type polyimide material in a solvent of a mixture of NMP (N-Methyl-2-pyrrolidone), GBL (γ-Butyrolactone), BC (Ethylene Glycol Monobutyl Ether), and the like. Further, the material of the alignment film with 0.5 wt % of the amine-system silane coupling agent added was applied onto the TFT substrate and the opposed substrate to be baked at 230° C. Then, polarized UV light including 254 nm was irradiated at a strength of 1000 mJ/cm² to form an alignment film. In the case of the photodimerization-type photo-alignment film, polarized UV light including 313 nm is irradiated at a strength of, for example, 100 mJ/cm². In the case of the photoisomerization-type photo-alignment film, polarized UV light including 365 nm is irradiated at a strength of, for example, 2000 mJ/cm².

However, the adhesive strength of the seal portion is not determined only by the characteristics of the alignment film. This is because the characteristics of the seal material largely affect. For example, an epoxy-system or acrylic-system organic material is used for the seal material. The seal material is shrunk when being hardened by light or heat. If the shrinkage ratio of the seal material by hardening is large, stress is generated between the substrate or the alignment film and the seal material to cause peeling-off of the seal portion.

As similar to the above, even in the case where the storage elastic modulus of the seal material is large, high stress is generated between the seal material and the substrate or the alignment film to cause peeling-off of the seal portion. In the present invention, the amine-system silane coupling agent is used as a coupling agent for the material of the alignment film, and the shrinkage ratio and the storage elastic modulus when hardening the seal material are set at predetermined values or smaller, so that the reliability of the seal portion is secured in the configuration in which the photo-aligned alignment film is overlapped with the seal material.

FIG. 7 is a table for showing the shrinkage ratios and the storage elastic moduli of two kinds of seal materials used in the experiment. The shrinkage ratio and the storage elastic modulus of a seal material ZZ are 5.5% and 9.6 Pa, respectively. The shrinkage ratio and the storage elastic modulus of a seal material AA are 4.7% and 9.2 Pa, respectively. The seal material ZZ is larger than the seal material AA in both of the shrinkage ratio and the storage elastic modulus. Therefore, the seal material ZZ is expected to be inferior to the seal material AA in the reliability of the seal portion. It should be noted that the shrinkage ratio of each seal material was evaluated using the modulus of volume change by a specific gravity cup method.

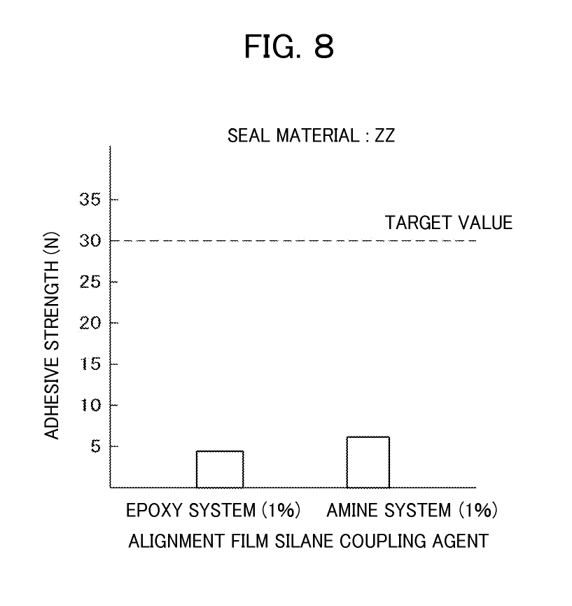

FIG. 8 is a graph obtained by evaluating the adhesive strength of the seal portion using the seal material ZZ in the case where as the material of the alignment film, 1% of the epoxy-system silane coupling agent was added to the coupling agent and 1% of the amine-system silane coupling agent was added thereto. In FIG. 8, the adhesive strength was larger in the case of using the amine-system silane coupling agent than in the case of using the epoxy-system silane coupling agent. However, in each case, the adhesive strength did not reach 30N of the target value.

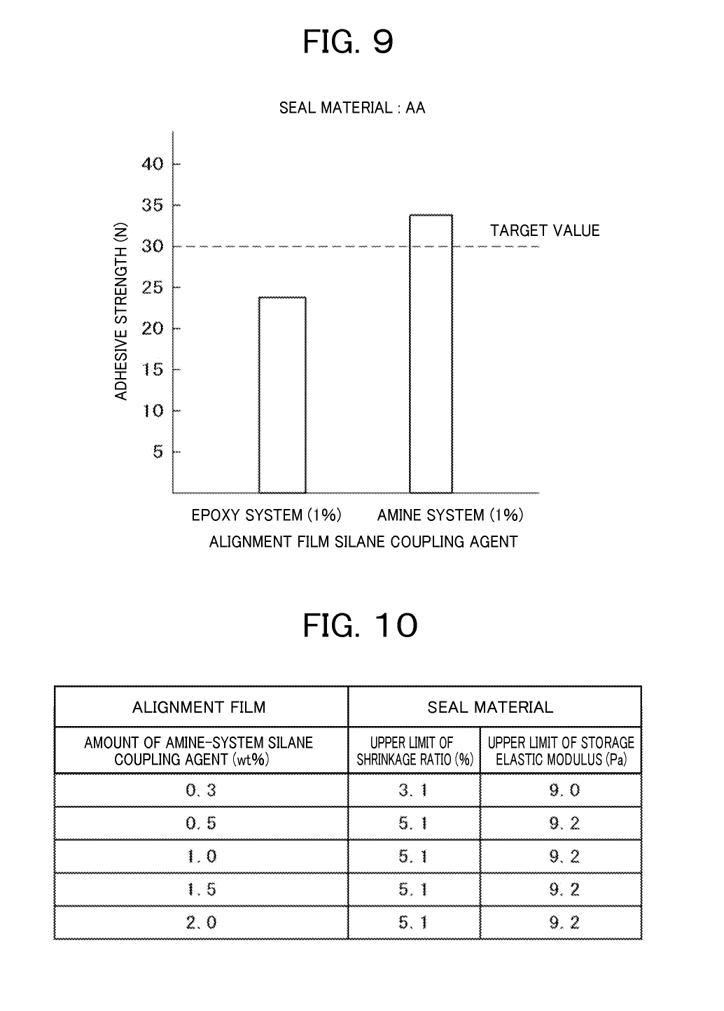

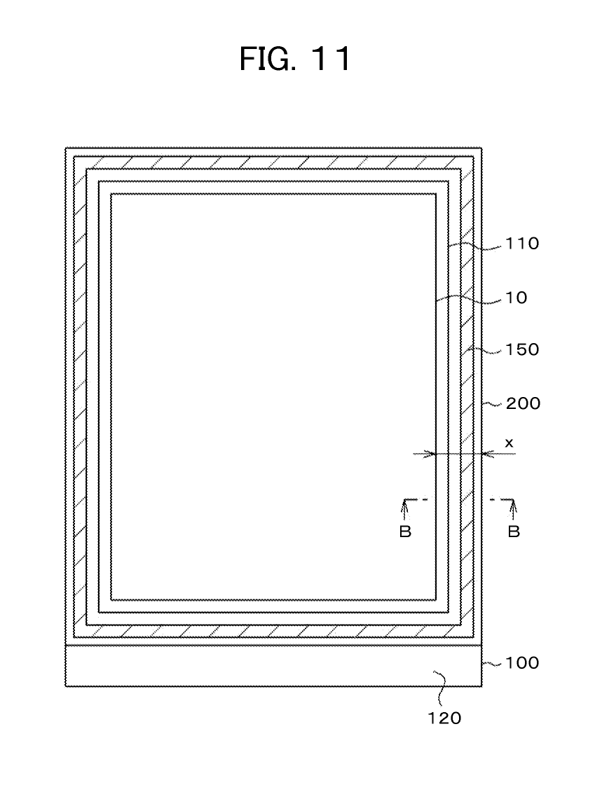

FIG. 9 is a graph obtained by evaluating the adhesive strength of the seal portion using the seal material AA in the case where as the material of the alignment film, 1% of the epoxy-system silane coupling agent was added to the coupling agent and 1% of the amine-system silane coupling agent was added thereto. The adhesive strength was larger in the case of using the seal material AA than in the case of using the seal material ZZ. Further, in FIG. 9, the adhesive strength was larger in the case of using the amine-system silane coupling agent than in the case of using the epoxy-system silane coupling agent.

In FIG. 9, in the case of using the epoxy-system silane coupling agent, the adhesive strength of the seal portion was 24N which was less than 30N of the target value. On the other hand, in the case of using the amine-system silane coupling agent, the adhesive strength of the seal portion was 34N which was over 30N of the target value. Specifically, as shown in FIG. 7 to FIG. 9, the amine-system silane coupling agent is used as the coupling agent of the alignment film, and a material with a shrinkage ratio and a storage elastic modulus that are predetermined values or smaller is used as the seal material. Accordingly, it is possible to obtain the configuration in which the seal material can be overlapped with the alignment film in the seal portion.

FIG. 10 shows a case in which in the case where the amine-system silane coupling agent was changed from 0.3 wt % to 2.0 wt %, the upper limit of the shrinkage ratio and the upper limit of the storage elastic modulus of the seal material were evaluated so as to secure an adhesive strength of 30N or higher in the seal portion. FIG. 10 shows that an adhesive strength of 30N or higher can be secured in the seal portion when the shrinkage ratio is 5.1% or smaller and the storage elastic modulus is 9.2 Pa or smaller in any one of the cases of 0.5 wt %, 1.0 wt %, 1.5 wt %, and 2.0 wt % of the amine-system silane coupling agent.

Further, FIG. 10 shows that an adhesive strength of 30N or higher can be secured in the seal portion when the shrinkage ratio of the seal material is 3.1% or smaller and the storage elastic modulus is 9.0 Pa or smaller in the case of 0.3 wt % of the amine-system silane coupling agent. FIG. 10 does not show values in the case of larger than 0.3% and smaller than 0.5%. This range can be regarded as a range in which an adhesive strength of 30N or higher can be secured in the seal portion using the seal material with a shrinkage ratio of 3.1% or smaller and a storage elastic modulus of 9.0 Pa or smaller. It should be noted that no liquid crystal molecules exist in the area where the seal is formed. Thus, no liquid crystal molecules are aligned. However, the area is referred to as an alignment film in the specification.

The specification describes that if the solution containing polyamide acid ester and polyamide acid is applied onto the substrate, the layers are separated from each other. However, the separation is not limited to a case in which the layers are vertically separated from each other at a specific interface. The separation of the layers includes a state in which more alignment film components having polyamide acid as a precursor exist on the lower side of the alignment film and more alignment film components having polyamide acid ester as a precursor exist on the upper side of the alignment film. Further, the alignment film components having polyamide acid as a precursor do not align the liquid crystal, but are referred to as an alignment film in the specification.

What is claimed is:

1. A liquid crystal display device comprising a first substrate having a first alignment film, a second substrate having a second alignment film, a seal material disposed between the first substrate and the second substrate, and liquid crystal sandwiched between the first substrate and the second substrate, wherein
the first alignment film and the second alignment film are overlapped with the seal material, the first alignment film and the second alignment film are made of material containing 0.5 wt % or larger and 2 wt % or smaller of a silane coupling agent, and the shrinkage ratio and the storage elastic modulus of the seal material evaluated using the modulus of volume change by a specific gravity cup method are 5.1% or smaller and 9.2 Pa or smaller, respectively.

2. The liquid crystal display device according to claim 1, wherein
the first alignment film is formed up to end portions of the first substrate, and the second alignment film is formed up to end portions of the second substrate.

3. A liquid crystal display device comprising a first substrate having a first alignment film, a second substrate having a second alignment film, a seal material disposed between the first substrate and the second substrate, and liquid crystal sandwiched between the first substrate and the second substrate, wherein
the first alignment film and the second alignment film are overlapped with the seal material, the first alignment film and the second alignment film are made of material containing 0.3 wt % or larger and smaller than 0.5 wt % of a silane coupling agent, and the shrinkage ratio and the storage elastic modulus of the seal material evaluated using the modulus of volume change by a specific gravity cup method are 3.1% or smaller and 9.0 Pa or smaller, respectively.

4. The liquid crystal display device according to claim 3, wherein
the first alignment film is formed up to end portions of the first substrate, and the second alignment film is formed up to end portions of the second substrate.

5. The liquid crystal display device according to claim 1, wherein
an amine-system silane coupling agent is used as the silane coupling agent.

6. The liquid crystal display device according to claim 5, wherein
the amine-system silane coupling agent is represented by [chemical structure]
